(19) United States
(12) Patent Application Publication
(10) Pub. No.: US 2011/0101547 A1
(43) Pub. Date: May 5, 2011

(54) FLUIDIZATION AERATION MIXING APPARATUS

(76) Inventor: Cach Van Nguyen, Hanoi (VN)

(21) Appl. No.: 12/679,906

(22) PCT Filed: Oct. 7, 2008
(86) PCT No.: PCT/VN08/00003

§ 371 Date: Aug. 6, 2010

(30) Foreign Application Priority Data
Oct. 18, 2007 (VN) 1-2007-02165

(51) Int. Cl. B01F 5/00; B01F 3/04

(52) U.S. Cl. 261/93

(57) ABSTRACT

The present invention relates to fluidization aeration mixing apparatus comprising a centrifugal ventilator (1), an air pipe (2) and an integrated unit of three centrifugal impellers. The integrated unit of three centrifugal impellers comprising three centrifugal impellers centrifugally operated independently with one another, integrated, coaxial and are spaced from each other by means of partition walls forming three centrifugal chambers consist of the upper chamber (4), the lower chamber (5) and the central chamber (3), the air pipe (2) having an end air-tight connected with the outlet of the centrifugal ventilator (1) and an another end air-tight connected with the suction inlet of the central centrifugal chamber (3) of the integrated unit of three centrifugal impellers, so that in the operating status of the fluidization aeration mixing apparatus, the air is, by means of the centrifugal ventilator (1), suctioned and then centrifugally pushed into the air pipe to enter into central centrifugal chamber (3), then centrifugally pushed out.

### TECHNICAL FIELD

The present invention relates to fluidization aeration mixing apparatus to aerate/disperse the air into water or into liquid medium. This fluidization aeration mixing apparatus can be used in aerobic fermentation, in wastewater treatment, treatment of polluted lake water or in aquaculture ponds, or can be used to mix/disperse between two gas and liquid phases (or between two phases flexible to one another) to improve the efficiency of the extraction of the substances to be exctracted from one phase to another.

### BACKGROUND OF INVENTION

In order to aerate the air into water at sufficient depth instead of on the surface of the liquid, until recently it has been widely used one of the two following solutions.

Firstly, air-compressor (a piston air-compressor, a membrane air-compressor, a rotary screw air-compressor or a turbine air-compressor) can be employed to compress the air up to the pressure sufficient to push this amount of air to transport along the air pipe to be dispersed into water at the required depth. This type of aeration is advantageous in that it is possible to aerate into the liquid medium a lagre amount of the air and can change easily the supplied air flow. However, the device of this type consumes a lot of energy because it requires three parts of energy simultaneously, namely: the energy to overcome mechanical friction resistance between piston and cylinder (or/and other mechanical systems—/Q₁/); the energy to change the internal energy of the air volume to compress the air volume to high pressure /Q₂/and the energy to transport the air volume generally from the suction inlet to the aeration opening /Q₃/. As to these energies, the energy to transport the air volume is generally much lower than the remaining two energy consumptions (due to the small air flow resistance).

Further, the hollow shaft turbine impeller (having the air pipe into the interior of the impeller shaft) can be employed. With this hollow shaft turbine mixer, the centrifugal movement of the impeller formed the reduced pressure region and therefore suctions the air into the impeller chamber. Simultaneously, the air and the liquid are mixed to each other by means of the venturi flow effect, right in the impeller section and on the transported flow. This hollow shaft turbine mixer is advantageous in respects to the simple construction, but the volume of the suctioned air is generally not so high and cannot change the supplied air flow. In case if it is desired to change the supplied air it is possible to use an extra forced air supply device to introduce the air into the mixing region. However, when the supplied air is sufficiently large, the supplied air volume shall immediately take the working region of the impeller and result in disruption of the mixing operation of the air-liquid of the device, because the air volume has covered the entire region surrounding the impeller to prevent the water from contacting directly with the impeller.

### SUMMARY OF THE INVENTION

An objective of the present invention is to reduce the majority of the energy consumption to overcome the friction resistance and to compress the air up to the high pressure, which are two disadvantages in the use of the known above-mentioned compressors. Simultaneously, the present invention utilizes the ability to transport a large air volume of the centrifugal ventilator and allows to adjust the air volume aerated into the liquid medium, which are two characteristics that could not be obtained by the known in the prior art hollow shaft turbine mixer.

In order to achieve this objective, the present invention provides a fluidization aeration mixing apparatus comprising a centrifugal ventilator, an air pipe and an integrated unit of three centrifugal impellers. The unit of three centrifugal impellers was integrated from three centrifugal impellers centrifugally operated independently with one another; they integrated coaxial and are spaced from each other by means of partition walls to form three centrifugal chambers consist of the upper chamber, the lower chamber, and the central chamber. The air pipe having an end air-tight connected with the outlet of the centrifugal ventilator and an another end air-tight connected with the suction inlet of the central centrifugal chamber of the integrated unit of centrifugal impellers, so that in operating status of the fluidization aeration mixing apparatus, the air is, by means of the centrifugal ventilator, suctioned and then centrifugally pushed into the air pipe to enter the central centrifugal chamber. Next, the centrifugal force generated by the central centrifugal chamber suctions and then further pushes this air volume into the mixing region, to mix with the amount of water that has been pushed into this mixing region from two upper and lower centrifugal chambers.

In one embodiment, the centrifugal ventilator and the integrated unit of three centrifugal impellers are disposed on the same shaft and operated by one common drive power unit.

In another embodiment, the centrifugal ventilator and the integrated unit of three centrifugal impellers are disposed on two abaxial axes and operated by two separate drive power units.

The intergrated unit of three centrifugal impellers can be integrated by integrally molding, welding or fixing with bolts.

Fluidization aeration mixing apparatus of the present invention can be used in aerobic fermentation, in the wastewater treatment, treatment of polluted lake water or in the aquaculture ponds, or can be used to mix/disperse between two gas and liquid phases (or between two phases flexible to one another), to improve the efficiency of the extraction of the substances to be exctracted from one phase to another.

### BRIEF DESCRIPTION OF DRAWINGS

FIG. 1 is a view showing the construction principle and operation of the fluidization aeration mixing apparatus in a preferred embodiment of the present invention.

### DETAILED DESCRIPTION OF PREFERRED EMBODIMENT

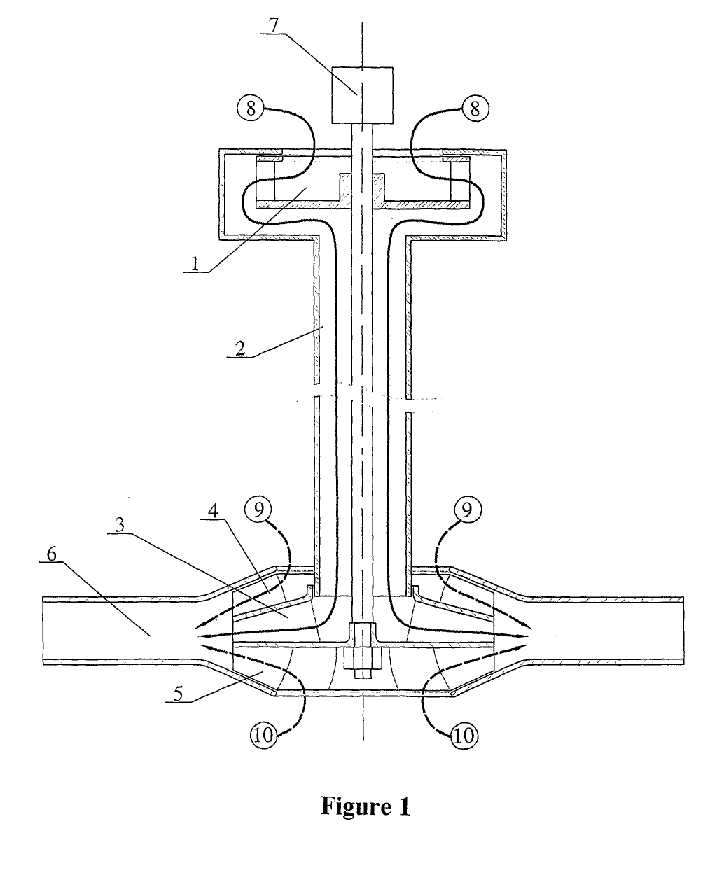

Construction and operation of the fluidization aeration mixing apparatus in a preferred embodiment of the present invention will be described in details with reference to FIG. 1. The fluidization aeration mixing apparatus of the present invention comprises three main components that are a centrifugal ventilator 1 operatively connected in the air-tight transported flow by means of an air pipe 2 with a central centrifugal chamber of a integrated unit of three centrifugal impellers. The integrated unit of three centrifugal impellers comprising three centrifugal impellers are fixedly integrated by integrally molding or welding or fixing with bolts, coaxial and are spaced from each other by means of partition walls forming three centrifugal chambers consist of the upper chamber 4, the lower chamber 5 and the central chamber 3. According to this embodiment of the present invention, the centrifugal ventilator 1 and the integrated unit of three centrifugal impellers are associated on the same shaft, are disposed in an air-tight support chamber and operated by means of an electric engine or by means of another respective drive power unit. According to another embodiment of the present invention, the centrifugal ventilator 1 and the integrated unit of three centrifugal impellers can also be disposed abaxially and operated by two separate drive power units. The entire apparatus assembled has the construction as shown in FIG. 1.

In operation, the centrifugal ventilator 1 suctions the air (or the first mobile phase) from outside the suction inlet to push the air into the outside of the air chamber of the centrifugal ventilator 1. The air then is passed along the air pipe 2 to the central centrifugal chamber 3. Due to the centrifugal force in the chamber 3, the air is pushed into the outlet channel 6. The transportation direction of the air flow (or the first mobile phase) is denoted by means of the arrow 8. Water (or the second mobile phase), due to the centrifugal force of two impellers in the chambers 4 and 5, is suctioned from the suction inlet and then pushed into the outlet channel 6. The transportation direction of the water is denoted by dash arrows 9 and 10. The outlet channel 6 can be sector-type radial pipe segments or only the common flowing periphery for all three phases (compositions).

In the outlet channel 6, three compositions comprising the amount of water supplied from the centrifugal chamber 4, the air supplied from the centrifugal chamber 3 and the amount of water supplied from the centrifugal chamber 5, moved at high flow rate in a turbulence state mix randomly with each other under fluidized bed conditions. Under these conditions, the air flow is torn and dispersed into small air bubbles; thereby, the liquid-air contact surface increased and the transportation rate of the oxygen volume from the air phase into water also increased.

The novelty of this apparatus is the intergrated unit of three centrifugal impellers in the synchronical operation with the centrifugal ventilator.

The separate integration of the three centrifugal impellers causes the centrifugation of three compositions be independently with each other: water through the upper chamber, the air through the middle chamber and water through the lower chamber. Therefore, the mixing occurs only in the outlet channel 6 in accordance with the randomization principle, it does not occur simultaneously in the centrifugal chambers due to the venturi effects. This mechanism allows to change the air volume supplied into the mixing region, in a broad range depending on the capacity of the centrifugal ventilator 1. In order to ensure the efficiency of the mass transportation, the length of the outlet channel 6 can vary from ⅓ chamber radius of impellers to metres, depending on the capacity of the engine or other respective drive power units thereof.

The separate operation of the centrifugal chamber 3 allows it to suction the air from the air pipe and push it into the mixing channel 6. Therefore, the centrifugal ventilator 1 only serves to transport large volumes of air from the ambient environment to the suction zone of impeller eye of the chamber 3. The simultaneously intergrated operation of these two factors has utilized the high and effective ability of transporting the air of the centrifugal ventilator, much higher than the use of air-compressors, i.e. to save substantially two energy losses (Q₁) and (Q₂), to minimize the majority of energy consumption generally compared to the use of air-compressors, because the air-compressors must consume the majority of energy to overcome the friction forces for mechanical movement elements (Q1) and to change internal energy due to the large change of the compression index (Q2) as described in the background of the present invention.

Simultaneously, together with the great ability to transport the air, only by changing the ventilator 1 it is possible to change the amount of supplied air, in the broad range corresponding to the ability to transport of the ventilator, and does not significantly depend on the depth in the water of the outlet, this effect could not be achieved by the aerators based on the venturi effect, as described in the background of the present invention.

Listing of claims claimed is:

1. A fluidization aeration mixing apparatus comprising a centrifugal ventilator, an air pipe and an integrated unit of three centrifugal impellers, wherein the integrated unit of three centrifugal impellers comprising three centrifugal impellers centrifugally operated independently with one another, integrated, coaxial and are spaced from each other by means of partition walls forming three centrifugal chambers consist of the upper chamber, the lower chamber, and the central chamber, the air pipe having an end air-tight connected with the outlet of the centrifugal ventilator and an another end air-tight connected with the suction of the central centrifugal chamber of the integrated unit of three centrifugal impellers, so that in the operating status of the fluidization aeration mixing apparatus, the air is, by means of the centrifugal ventilator, suctioned and then centrifugally pushed into the air pipe to enter into central centrifugal chamber, then centrifugally pushed out.

2. The fluidization aeration mixing apparatus as claimed in claim 1, wherein centrifugal ventilator and the integrated unit of three centrifugal impellers are disposed on the same shaft and operated by one common drive power unit.

3. The fluidization aeration mixing apparatus as claimed in claim 1, wherein centrifugal ventilator and the integrated unit of three centrifugal impellers are disposed on two abaxial axes and operated by two separate drive power units.

4-6. (canceled)

7. The fluidization aeration mixing apparatus as claimed in claim 1, wherein three centrifugal impellers are integrated by integrally molding.

8. The fluidization aeration mixing apparatus as claimed in claim 1, wherein three centrifugal impellers are integrated by welding.

9. The fluidization aeration mixing apparatus as claimed in claim 1, wherein three centrifugal impellers are integrated by fixing with bolts.

10. The fluidization aeration mixing apparatus as claimed in claim 2, wherein three centrifugal impellers are integrated by integrally molding.

11. The fluidization aeration mixing apparatus as claimed in claim 2, wherein three centrifugal impellers welding.

12. The fluidization aeration mixing apparatus in claim 2, wherein three centrifugal impellers are integrated by fixing with bolts.

13. The fluidization aeration mixing apparatus as claimed in claim 3, wherein three centrifugal impellers are integrated by integrally molding.

14. The fluidization aeration mixing apparatus as claimed, in claim 3, wherein three centrifugal impellers are integrated by welding.

15. The fluidization aeration mixing apparatus in claim 3, wherein three centrifugal impellers are integrated by fixing with bolts.
